(19) United States
(12) Patent Application Publication
(10) Pub. No.: US 2008/0177007 A1
(43) Pub. Date: Jul. 24, 2008

(54) ACETALDEHYDE SCAVENGER AND POLYESTER BLEND CONTAINING THE SAME

(75) Inventors: Roy Wu, Taoyuan Hsien (TW); Johnson J. G. Wang, Taoyuan Hsien (TW)

Correspondence Address: FOLEY AND LARDNER LLP;SUITE 500, 3000 K STREET NW, WASHINGTON, DC, 20007, US

(73) Assignee: FAR EASTERN TEXTILE LTD.

(21) Appl. No.: 12/015,620

(22) Filed: Jan. 17, 2008

(30) Foreign Application Priority Data
Jan. 19, 2007 (TW) 096102088

(51) Int. Cl. C08G 63/02; C08F 283/01

(52) U.S. Cl. 525/418; 528/308; 528/308.7

(57) ABSTRACT

An acetaldehyde scavenger includes: a polymerization product of at least one of an aromatic dicarboxylic acid having a carbon number from 8 to 16 and an ester derivative of the aromatic dicarboxylic acid, and a diol compound having a carbon number from 3 to 15.

### CROSS-REFERENCE TO RELATED APPLICATION

This application claims priority of Taiwanese application no. 096102088, filed on Jan. 19, 2007.

### BACKGROUND OF THE INVENTION

1. Field of the Invention

This invention relates to an acetaldehyde scavenger and a polyester blend containing the same.

2. Description of the Related Art

Polyethylene terephthalate (PET) is commonly used in the production of containers for receiving food or drink, e.g., beverage, mineral water, juice and edible oil. The PET container exhibits good properties, such as chemical stability, barrier property, light weight, low cost and recyclable.

However, the PET container normally contains a small amount of undesired acetaldehyde resulting from heat decomposition during polymerization, or subsequent processing, which can result in contamination to water or food received in the PET container. Thus, there is still a need to reduce the content of the acetaldehyde present in the PET container.

In order to reduce the content of acetaldehyde present in PET, various acetaldehyde scavengers have been proposed to mix with PET pellets. U.S. Pat. No. Nos. 4,837,115, 5,258,233, 6,191,209, 6,239,233, and 6,790,499 disclose use of amide, amine, poly vinyl alcohol, ethylene-vinyl alcohol copolymer (EVOH) or polyhydric alcohol as acetaldehyde scavengers, respectively. Alternatively, the acetaldehyde content can also be reduced by improving the process of polymerization of PET or processing of PET. U.S. Pat. Nos. 5,656,221, 6,099,778, and 5,648,032 disclose an improved process by introducing a nitrogen-containing substance, such as nitrogen, over a melt polymer of the polymerization system, or by adding amine or amide into a melt polymer of a processing system. U.S. Pat. Nos. 5,922,828 and 6,559,271 disclose the use of a titanium catalyst and a phosphorous-containing substance as a stabilizer for reduction of acetaldehyde. U.S. Pat. No. 6,489,434 discloses the use of stabilizers and antioxidants for reduction of acetaldehyde.

However, the nitrogen-containing substance when used as an acetaldehyde scavenger can react with acetaldehyde to form a conjugated imine, thereby causing the polymeric pellet to be yellowish, which has an adverse effect on the application of the pellets. Likewise, the polymeric pellets also become yellowish when the titanium catalyst is used in the polymerization.

In addition, polyvinyl alcohol, ethylene-vinyl alcohol copolymer (EVOH) or polyhydric alcohol used as acetaldehyde scavengers, which have a poor resistance to the processing temperature, tend to decompose during the processing with PET pellets.

### SUMMARY OF THE INVENTION

Therefore, the object of the present invention is to provide an acetaldehyde scavenger that can overcome the aforesaid drawbacks associated with the prior art.

Another object of this invention is to provide a method for making a polyester blend including the acetaldehyde scavenger.

According to the present invention, the acetaldehyde scavenger comprises a polymerization product of at least one of an aromatic dicarboxylic acid having a carbon number from 8 to 16 and an ester derivative of the aromatic dicarboxylic acid, and a diol compound having a carbon number from 3 to 15.

According to another aspect of this invention, a method for making a polyester blend comprises: (a) melt blending a mixture of an acetaldehyde scavenger and polyethylene terephthalate under a temperature ranging from 200° C. to 290° C. so as to form a melt blend, the acetaldehyde scavenger being a polymerization product of at least one of an aromatic dicarboxylic acid having a carbon number from 8 to 16 and an ester derivative of the aromatic dicarboxylic acid, and a diol compound having a carbon number from 3 to 15; and (b) extruding the melt blend under a vacuum condition.

### DETAILED DESCRIPTION OF THE PREFERRED EMBODIMENT

The preferred embodiment of an acetaldehyde scavenger according to this invention includes a polymerization product of at least one of an aromatic dicarboxylic acid having a carbon number from 8 to 16 and an ester derivative of the aromatic dicarboxylic acid, and a diol compound having a carbon number from 3 to 15.

Preferably, the diol compound is selected from the group consisting of propylene glycol, butylene glycol, pentamethylene glycol, 2,2-dimethyltrimethylene glycol, hexamethylene glycol, decamethylene glycol, 2-methyl-1,3-propanediol, 3-methyl-1,5-pentylene glycol, dihydroxy cyclohexane, cyclohexane dimethanol, resorcinol, hydroquinone, 1,5-dihydroxy naphthalene, bis(p-hydroxy)diphenyl, bis(p-hydroxyphenyl)methane, bis(p-hydroxyphenyl)propane, and combinations thereof.

More preferably, the diol compound is selected from the group consisting of propylene glycol, butylene glycol, pentamethylene glycol, hexamethylene glycol, 2-methyl-1,3-propanediol, and combinations thereof.

Preferably, the aromatic dicarboxylic acid is selected from the group consisting of terephthalic acid, isophthalic acid, phthalic acid, bi-benzoic acid, bis(p-carboxyphenyl)methane, 1,5-naphthalene dicarboxylic acid, 2,6-naphthalene dicarboxylic acid, 2,7-naphthalene dicarboxylic acid, p-oxy(p-carboxyphenyl)benzoic acid, ethylene-bis(p-oxybenzoic acid), phenanthrene dicarboxylic acid, anthracene dicarboxylic acid, 4,4′-sulfonyl dibenzoic acid, and combinations thereof.

More preferably, the aromatic dicarboxylic acid is selected from the group consisting of terephthalic acid, isophthalic acid, phthalic acid, and combinations thereof.

Preferably, the polymerization product is selected from the group consisting of polypropylene terephthalate, polybutylene terephthalate, polybutylene(terephthalate-isophthalate), polypentylene terephthalate, polyhexylene terephthalate, poly(2-methyl-1,3-propylene)terephthalate, and combinations thereof.

Preferably, the polymerization product has a relative viscosity ranging from 0.5 to 5.0, more preferably, from 1.0 to 4.0, and most preferably, from 1.5 to 3.0.

Preferably, the polymerization product has a melting point ranging from 30° C. to 280° C., more preferably, from 40° C. to 265° C., and most preferably, from 50° C. to 250° C.

A polyester blend is also disclosed herein, and includes: a blending product of the acetaldehyde scavenger and polyethylene terephthalate.

Preferably, the acetaldehyde scavenger is in an amount ranging from 0.1 to 30 parts by weight per 100 parts by weight of the blending product, and more preferably from 0.1 to 10 parts by weight per 100 parts by weight of the blending product.

The polyester blend is prepared according to a method including the steps of: (a) melt blending a mixture of the acetaldehyde scavenger and polyethylene terephthalate under a temperature ranging from 200° C. to 290° C. so as to form a melt blend; and (b) extruding the melt blend under a vacuum condition.

Preferably, the vacuum condition is conducted at a pressure not greater than 500 torr, and more preferably, not greater than 200 torr.

The merits of the polyester blend of this invention will become apparent with reference to the following Examples and comparative Examples.

### EXAMPLES

### Chemicals Used for Examples 1-29 (E1-29) and Comparative Examples 1-6 (CE1-6)

Table 1 shows the chemical properties of polyester pellets employed for Examples 1-29 and Comparative Examples 1-6, respectively.

TABLE 1

| | | | | | | Acid | | | Melting |
|---|---|---|---|---|---|---|---|---|---|
| | | | | | DEG | value | H-AA | E-AA | point |
| | RV | L | La | Lb | (wt %) | (meq/kg) | (ppm) | (ppm) | (° C.) |
| PET_{I} | 1.613 | 61.0 | 1.2 | −2.8 | 1.28 | 51.6 | 32.5 | 48.2 | 250 |
| PET_{II} | 1.615 | 64.0 | 1.8 | −3.3 | 1.32 | 40.5 | 48.1 | 60.6 | 250 |
| PBT | 2.005 | 94.5 | −2.2 | 2.6 | — | 33.1 | 0.7 | 3.1 | 225 |
| PBTI | 1.936 | 78.6 | −1.9 | 2.1 | — | 29.2 | 0.7 | 6.1 | 160 |
| PPT | 2.134 | 86.8 | −3.1 | 8.1 | — | 28.0 | 0.3 | 12.4 | 230 |
| PHT | 2.016 | 84.6 | −0.1 | 6.6 | — | 61.4 | 1.3 | 6.2 | 145.5 |
| PMPT | 2.105 | 60.8 | −0.8 | 18.2 | — | 26.5 | 1.2 | 6.8 | 52.3 |
| PPDT | 2.527 | 76.8 | −0.8 | 6.6 | — | 26.3 | 1.4 | 13.1 | 130.2 |
| PETI | 1.501 | 70.3 | −1.4 | 10.4 | 4 | 61.8 | 65.6 | 83.2 | 110 |
| PETA | 1.781 | 74.8 | −2.8 | 1.6 | 0.59 | 20.7 | 19.7 | 29.6 | 190 |

PET (polyethylene terephthalate): Model no. CRB-827 available from Far Eastern Textile. The PET_{I} and PET_{II} were manufactured in different batches;

PBT (polybutylene terephthalate): Model No. PBT Grade 1100-211A available from Chang Chun Plastics Co., LTD;

PBTI: polybutylene (terephthalate-isophthalate) synthesized by the inventor. The molar ratio of isophthalate to the combination of dimethyl terephthalate and isophthalate was 7/20 and the molar ratio of butanediol to the combination of dimethyl terephthalate and isophthalate was 2/1 in the reactants;

PPT (polypropylene terephthalate): Model no. SORONA J2229 available from Du Pont;

PHT (polyhexylene terephthalate): synthesized by the inventor, wherein the molar ratio of hexanediol to dimethyl terephthalate was 2/1 in the reactants;

PMPT (poly(2-methyl-1,3-propylene)terephthalate): synthesized by the inventor, wherein the molar ratio of 2-methyl-1,3-propanediol to dimethyl terephthalate was 2/1 in the reactants;

PPDT (polypentylene terephthalate): synthesized by the inventor, wherein the molar ratio of pentanediol to dimethyl terephthalate was 2/1 in the reactants;

PETI: Poly(ethylene terephthalate-co-isophthalate); Model No. CS-475M available from Far Eastern Textile;

PETA: Poly(ethylene terephthalate-co-adipate): Model No. CS-113 available from Far Eastern Textile;

RV (relative viscosity): an index of the molecular weight of a polymer.

L value, La and Lb: color index of polyester pellets, which were measured using a colorimeter;

Diethylene glycol (DEG) and acid value: indexes used as references for examining chemical properties of the polyester blend;

H-AA (High temperature acetaldehyde): the content of free acetaldehyde present in the polyester pellets or preforms. The H-AA was determined through the following method. A predetermined amount of the sample was immersed in liquid nitrogen in a grinder for 5 minutes and is subsequently ground into powders. The powders were subjected to screening so as to obtain particles of 30 mesh (0.3˜0.8 mm). 1 g of the sample, i.e., the particles of 30 mesh, was placed in a sampling flask. The sampling flask was then sealed and put into a headspace sampler. Thereafter, the sample was heated under a temperature of 150° C. for 60 minutes. The gas generated in the sampling flask during heating was sampled using a syringe and was injected into a gas chromatography (GC) so as to calculate the acetaldehyde content. The operation conditions of GC were as follows: The temperature of the injecting port was 125° C. The column was 2 m×⅛″ PROPAK Q B0˜100 mesh and the column temperature was 165° C. The temperature of the detector is 270° C. A nitrogen flow rate (99.9999%) was 5.0 ml/min. A hydrogen flow rate was 40 ml/min and the air flow rate was 400 ml/min.

E-AA (Extract acetaldehyde): the total content of acetaldehyde present in the PET pellets or preforms, including the free acetaldehyde and the precursor of acetaldehyde. E-AA was measured in a manner similar to that of H-AA except that the sample was in an amount of 0.25 g and was received together with 0.5 g distilled water in the sampling flask. The sample was heated under a temperature of 150° C. for 120 minutes in the head space sampler.

### The Blending Conditions

The acetaldehyde scavenger and the PET employed in the Examples were mixed using a Twin Screw Extruder (JSW TEX30α) so as to form a polyester blend. The screw temperature of the extruder was set in a range from 200° C. to 260° C. The temperatures of the different segments of the extrusion screw were about 201° C., 236° C., 237° C., 236° C., 243° C., 244° C., 248° C., 246° C., 260° C., 256° C., 255° C. and 257° C., respectively. The temperature of the die was about 250˜260° C. The melting temperature was below 270° C. The pressure of the die was about 0.7 MPa. The rotational speed of the screw was about 250 rpm/50 Hz. The feeding rate was about 19 kg/hr. The extruder was operated at a vacuum condition for the Examples and Comparative Examples. The polyester blend, which was extruded from the die, was cooled by passing through a water bath and was subsequently cut into pellets by a cutter at a rotation speed of 1100 rpm. The polyester blend pellets were dried for further analysis.

### Examples 1-12

PET_{I} polyester pellets were dried under a temperature of 130° C. for 6 hr and PBT polyester pellets (serving as the acetaldehyde scavenger) were dried under a temperature of 100° C. for 4 hr. The dried PET_{I} polyester pellets were subsequently mixed with the dried PBT polyester pellets. The weight percentage of the dried PBT polyester pellets based on a total weight (3 kg) of PBT and PET_{I} for each Example is shown in Table 2. The polyester pellet mixture for each Example was fed into a hopper of the twin screw extruder, and was extruded under a vacuum condition shown in Table 2.

### Comparative Example 1

### PET_{I}

We used bottle-grade resin (PET_{I}) as Comparative Example 1, which was without the acetaldehyde scavenger.

The properties of Examples 1-12 and Comparative Example 1 were measured and are shown in Table 2.

TABLE 2

| | | | Properties of the polyester blend | | | | | | | |
|---|---|---|---|---|---|---|---|---|---|---|
| | PBT | Vacuum | | | | | | Acid | | |
| | amount | degree | | | | | DEG | value | H-AA | E-AA |
| | (wt %) | (torr) | RV | L | La | Lb | (wt %) | (meq/kg) | (ppm) | (ppm) |
| E1 | 0.1 | 76 | 1.576 | 63.7 | −0.2 | −0.3 | 1.15 | 49.9 | 5.3 | 17.5 |
| E2 | 0.2 | 76 | 1.567 | 57.6 | −0.7 | −1.0 | 1.15 | 49.9 | 5.3 | 20.3 |
| E3 | 0.4 | 76 | 1.583 | 67.8 | 3.4 | −1.9 | 1.17 | 49.4 | 5.1 | 16.3 |
| E4 | 0.6 | 76 | 1.576 | 67.1 | 1.0 | −2.8 | 1.15 | 49.1 | 5.3 | 17.0 |
| E5 | 0.8 | 76 | 1.578 | 67.0 | 0.1 | −1.8 | 1.11 | 48.8 | 5.2 | 16.7 |
| E6 | 1.0 | 76 | 1.575 | 67.4 | −0.1 | 0.2 | 1.32 | 50.4 | 5.6 | 15.7 |
| E7 | 2.0 | 76 | 1.572 | 66.9 | 0.6 | −1.0 | 1.30 | 51.0 | 5.9 | 18.1 |
| E8 | 4.0 | 380 | 1.576 | 80.5 | −0.5 | −2.7 | 1.19 | 50.0 | 12.1 | 24.1 |
| E9 | 6.0 | 380 | 1.582 | 80.7 | −0.6 | −3.2 | 1.14 | 49.2 | 12.3 | 21.6 |
| E10 | 8.0 | 380 | 1.580 | 82.1 | −0.5 | −3.0 | 1.07 | 47.9 | 11.1 | 18.2 |
| E11 | 10.0 | 76 | 1.617 | 67.0 | 0.8 | −0.2 | 1.05 | 46.2 | 5.9 | 18.1 |
| E12 | 10.0 | ambient | 1.581 | 67.8 | 0.4 | 0.4 | 1.19 | 50.9 | 14.0 | 25.7 |
| CE1 | — | — | 1.613 | 61.0 | 1.2 | −2.8 | 1.28 | 51.6 | 32.5 | 48.2 |
| (PET_{I}) | | | | | | | | | | |

In Table 2, the vacuum degree is the pressure measured at an end portion of the twin-screw extruder. It is apparent that, from the data shown in Table 2, the polyester blend of Example 12, i.e., containing PET_{I} and 10 wt % PET, exhibits a reduction of the H-AA and E-AA values by about 50%, when compared to the PET_{I} polyester of Comparative Example 1.

Furthermore, based on the data of Table 2, it is evident that there is a tendency that the higher the vacuum degree, i.e., the lower the vacuum value, the lower will be the H-AA and E-AA values. Surprisingly, H-AA and E-AA of the polyester blend of Example 1, i.e., containing 0.1 wt % PBT, were reduced by about 80% and about 64%, respectively, as compared to the PET, polyester of Comparative Example 1.

In addition, since the polyester blend of each Example has a RV value similar to that of the PET_{I} polyester of Comparative Example 1, addition of PBT to polyester does not affect the mechanical properties of the product made from the polyester blend as compared to those of the products made solely from PET. similarly, according to the color indices shown in Table 2, it is evident that addition of PBT to the polyester blend does not render the polyester blend yellowish. Furthermore, since the DEG and acid value for each Example are similar to or lower than those of Comparative Example 1, addition of PBT to the polyester blend does not adversely affect chemical properties of the product made from the polyester blend as compared to those made solely from PET.

### Examples 13-18

The blending conditions of each of Examples 13-18 were similar to those of Examples 1-12, except that PBTI was used as the acetaldehyde scavenger. In addition, the weight of the polyester blend was 3 kg for each of Examples 13-16 and was 10 kg for each of Examples 17 and 18. The vacuum conditions and the properties of the polyester blend for each of Examples 13-18 are shown in Table 3.

TABLE 3

| | | | Properties of the polyester blend | | | | | | | |
|---|---|---|---|---|---|---|---|---|---|---|
| | PBTI | Vacuum | | | | | | Acid | | |
| | amount | degree | | | | | DEG | value | H-AA | E-AA |
| | (wt %) | (torr) | RV | L | La | Lb | (wt %) | (meq/kg) | (ppm) | (ppm) |
| E13 | 2.0 | 456 | 1.574 | 66.7 | 0.2 | 0.6 | 1.24 | 53.5 | 19.1 | 31.2 |
| E14 | 4.0 | 456 | 1.597 | 64.3 | 0.1 | 0.3 | 1.21 | 51.5 | 19.4 | 31.5 |
| E15 | 6.0 | 456 | 1.587 | 65.4 | −0.2 | 0.6 | 1.23 | 51.9 | 18.1 | 28.3 |
| E16 | 8.0 | 456 | 1.593 | 65.1 | 0.3 | 0.6 | 1.18 | 53.2 | 18.7 | 28.5 |
| E17 | 10.0 | 152 | 1.617 | 66.9 | 2.5 | 0.3 | 1.27 | 50.7 | 5.7 | 20.2 |
| E18 | 10.0 | 304 | 1.610 | 66.5 | −0.6 | 4.1 | 1.09 | 52.7 | 13.1 | 22.8 |
| CE1 | — | — | 1.613 | 61.0 | 1.2 | −2.8 | 1.28 | 51.6 | 32.5 | 48.2 |
| (PET_{I}) | | | | | | | | | | |

From the data shown in Table 3, the content of acetaldehyde present in the polyester pellets can be reduced by addition of PBTI as acetaldehyde scavenger to the PET pellets. The higher the vacuum degree, the lower will be the H-AA and E-AA values.

### Examples 19-24

The blending conditions of each of Examples 19-24 were similar to those of Examples 1-12, except that PPT was used as the acetaldehyde scavenger. The properties of the polyester blend of Examples 19-24 thus formed are shown in Table 4.

TABLE 4

| | | | Properties of the polyester blend | | | | | | | |
|---|---|---|---|---|---|---|---|---|---|---|
| | PPT | Vacuum | | | | | | Acid | | |
| | amount | degree | | | | | DEG | value | H-AA | E-AA |
| | (wt %) | (torr) | RV | L | La | Lb | (wt %) | (meq/kg) | (ppm) | (ppm) |
| E19 | 1.0 | 76 | 1.581 | 71.3 | 0.1 | −2.1 | 1.23 | 50.2 | 8.3 | 19.4 |
| E20 | 2.0 | 76 | 1.585 | 71.8 | 0.3 | −2.4 | 1.23 | 49.0 | 7.1 | 17.0 |
| E21 | 4.0 | 76 | 1.583 | 72.2 | −0.1 | −1.8 | 1.20 | 48.2 | 6.8 | 16.8 |
| E22 | 6.0 | 76 | 1.594 | 73.3 | −0.3 | −1.3 | 1.19 | 47.8 | 5.0 | 15.3 |
| E23 | 8.0 | 76 | 1.604 | 73.8 | −0.7 | −0.5 | 1.16 | 47.0 | 5.0 | 16.3 |
| E24 | 10.0 | 76 | 1.612 | 75.8 | −0.5 | −0.4 | 1.13 | 46.8 | 4.9 | 16.0 |
| CE1 | — | — | 1.613 | 61.0 | 1.2 | −2.8 | 1.28 | 51.6 | 32.5 | 48.2 |
| (PET_{I}) | | | | | | | | | | |

As compared to Comparative Example 1, the polyester blend of each Example exhibits a reduction of H-AA by 80% and a reduction of E-AA by 65%. The results show the content of acetaldehyde present in the polyester blend can be reduced by addition of PPT as acetaldehyde scavenger to the PET pellets.

### Examples 25-27

The blending conditions of each of Examples 25-27 were similar to those of Examples 1-12, except that PET_{II} was used and that 1 wt % PPDT, 1 wt % PMPT and 1 wt % PHT was used as the acetaldehyde scavenger for Examples 25-27, respectively.

### Comparative Example 2

### PET_{II}

We used bottle-grade PET resin (PET_{II}) as Comparative Example 2, which was without the acetaldehyde scavenger.

The properties of product of Examples 25-27 and Comparative Example 2 are shown in Table 5.

TABLE 5

| | | | Properties of the polyester blend | | | | | | | |
|---|---|---|---|---|---|---|---|---|---|---|
| | acetaldehyde | Vacuum | | | | | | Acid | | |
| | scavenger | degree | | | | | DEG | value | H-AA | E-AA |
| | (wt %) | (torr) | RV | L | La | Lb | (wt %) | (meq/kg) | (ppm) | (ppm) |
| E25 | PPDT | 46 | 1.579 | 67.2 | −2.3 | 0.5 | 1.30 | 45.4 | 8.6 | 21.8 |
| E26 | PMPT | 46 | 1.574 | 66.1 | −0.9 | 1.3 | 1.30 | 44.5 | 8.2 | 19.3 |
| E27 | PHT | 46 | 1.564 | 67.9 | 2.6 | 1.4 | 1.32 | 46.5 | 7.4 | 27.6 |
| CE2 | — | — | 1.615 | 64.0 | 1.8 | −3.3 | 1.32 | 40.5 | 48.1 | 60.6 |
| (PET_{II}) | | | | | | | | | | |

From Table 5, it is shown that the use of PPDT, PMPT, PHT as acetaldehyde scavenger can reduce the acetaldehyde contents present in the polyester blend thus formed.

### Comparative Examples 3 and 4

The blending conditions of each of Comparative Examples 3 and 4 were similar to those of Examples 1-12, except that Comparative Example 3 was a polyester blend containing 90 wt % PET_{I} and 10 wt % PETI and Comparative Example 4 was a polyester blend containing 90 wt % PET_{I} and 10 wt % PETA. It is noted that the diol for forming PET_{I}, PETI and PETA was ethylene glycol, i.e., the diol having a carbon number less than 3.

The properties of the polyester blends of Comparative Examples 3 and 4 thus formed are shown in Table 6.

TABLE 6

| | | | Properties of the polyester blend | | | | | | | |
|---|---|---|---|---|---|---|---|---|---|---|
| | | Vacuum | | | | | | Acid | | |
| | Additive | degree | | | | | DEG | value | H-AA | E-AA |
| | (1 wt %) | (torr) | RV | L | La | Lb | (wt %) | (meq/kg) | (ppm) | (ppm) |
| CE3 | PETI | 76 | 1.545 | 71.4 | −1.1 | 3.7 | 1.24 | 56.9 | 26.8 | 37.9 |
| CE4 | PETA | 76 | 1.571 | 67.2 | −2.6 | 1.2 | 1.42 | 50.8 | 23.0 | 31.6 |
| CE1 | — | — | 1.613 | 61.0 | 1.2 | −2.8 | 1.28 | 51.6 | 32.5 | 48.2 |
| (PET_{I}) | | | | | | | | | | |

Comparing the results shown in Table 6 and those of Example 12, it is evident that the polyester blends of Comparative Examples 3 and 4, which comprises 90 wt % FET and 10 wt % of a polyester made from a diol of a carbon number less than 3, exhibit an acetaldehyde reduction inferior to that of Example 12, which comprise 90 wt % PET and 10 wt % of a polyester made from a diol of a carbon number greater than 3.

In addition, the polyester blends of Examples 13-16, having less than 10% wt of the acetaldehyde scavenger and being extruded under a pressure of 456 torr, exhibit an acetaldehyde reduction superior to those of Comparative Examples 3 and 4.

### The Heat Properties of the Acetaldehyde Scavenger

In order to understand the influence of the acetaldehyde scavenger of this invention on the formability of the polyester blends, heat properties such as melting point, crystal energy and heat of fusion for Examples 11, 17 and 24 and Comparative Example 1 were determined by Differential Scanning Calorimeter (DSC). The results are shown in Table 7.

TABLE 7

| | Acetaldehyde | Melting | Crystal | Heat of |
|---|---|---|---|---|
| | scavenger | point (° C.) | energy (J/g) | fusion (J/g) |
| E11 | PBT (10%) | 245.36 | 48.07 | 32.86 |
| E17 | PBTI (10%) | 245.90 | 39.31 | 34.65 |
| E24 | PPT (10%) | 246.80 | 38.86 | 34.65 |
| CE1 (PET₁) | — | 250.07 | 35.65 | 39.13 |

From the results shown in Table 7, the polyester blends of Examples 11, 17 and 24, in which PBT, PBTI, PPT were added, although having a melting point lower than that of the PET_{I} polyester of Comparative Example 1, exhibit both the crystal energy and heat of fusion similar to those of the PET_{I} polyester of Comparative Example 1. Hence, the polyester blends of this invention can be subjected to conventional processing conditions without any significant modification in the production of articles having good dimensional stability and mechanical strength.

### Solid State Polymerization and Formability Test

### Example 28

In this Example, 8 kg polyester blend obtained using the procedure of Example 17 were added into a 250 L reactor and were subjected to solid state polymerization under a temperature of 235° C. for 3 hr and a pressure of 1.5 torr.

### Comparative Example 5

The solid state polymerization condition of Comparative Example 5 was the same as Example 28, except that Comparative Example 5 was pure PET_{I} without addition of the acetaldehyde scavenger.

The properties of the solid state polymerized resins of Example 28 and Comparative Example 5 were determined and are listed in Table 8.

TABLE 8

| | Inherent | | |
|---|---|---|---|
| | viscosity (dL/g) | H-AA (ppm) | E-AA (ppm) |
| E28 | 0.798 | 0.6 | 6.9 |
| CE5 | 0.798 | 1.2 | 9.0 |

The results in Table 8 show that Example 28 exhibited an inherent viscosity similar to that of Comparative Example 5. It is evident that the solid state polymerization is not adversely affected by addition of the PBTI into the polyester blend and that the PETI-containing polyester blend can be used in forming a bottle preform.

### Example 29

The solid state polymerized resin obtained from Example 28 was subjected to injection molding (Model JW-150SD-PET).

### Comparative Example 6

The solid state polymerized resin obtained from Comparative Example 5 was subjected to injection molding (Model JW-1500D-PET) for comparison.

The properties of the preforms made by injection molding are listed in Table 9. Since the injection molding apparatus employed in Example 29 and Comparative Example 6 is an experimental type apparatus and has a relatively higher shearing rate than that of a production machine, the acetaldehyde contents present in the preform of Example 29 and Comparative Example 6 are therefore higher.

TABLE 9

| | Inherent | | |
|---|---|---|---|
| | viscosity (dL/g) | H-AA (ppm) | E-AA (ppm) |
| E29 | 0.750 | 18.0 | 24.3 |
| CE6 | 0.743 | 26.7 | 41.8 |

From the data shown in Table 9, it is evident that a bottle preform of Example 29 has an E-AA value considerably lower than that of Comparative Example 6. This reveals that the content of the acetaldehyde present in the bottle preform can be reduced by addition of the acetaldehyde scavenger of this invention into the polyester to be blended. To be specific, each of Examples 28 and 29, which illustrate a solid state polymerized resin and a bottle preform made by injection molding, respectively, exhibits lower H-AA and E-AA values, and is consistent with the data shown in Table 3, when compared to that of the PET polyester. Accordingly, the polyester blend of this invention, which contains the aromatic polyester, serving as the acetaldehyde scavenger, and the PET, can exhibit lower H-AA and E-AA values even when the polyester blend of this invention is further subjected to subsequent processing, such as solid state polymerization and injection molding.

It has thus been shown that the acetaldehyde scavenger of this invention, which contains a polymerization product of at least one of the aromatic dicarboxylic acid having a carbon number from 8 to 16 and an ester derivative of the aromatic dicarboxylic acid, and the diol compound having a carbon number from 3 to 15, exhibits excellent ability in reduction of acetaldehyde present in the polyester blend.

While the invention has been described in detail and with reference to specific embodiments thereof, it is apparent to one skilled in the art that various modifications and variations can be made without departing from the spirit of the present invention.

What is claimed is:

1. An acetaldehyde scavenger comprising:
a polymerization product of at least one of an aromatic dicarboxylic acid having a carbon number from 8 to 16 and an ester derivative of the aromatic dicarboxylic acid, and a diol compound having a carbon number from 3 to 15.

2. The acetaldehyde scavenger of claim 1, wherein said diol compound is selected from the group consisting of propylene glycol, butylene glycol, pentamethylene glycol, 2,2-dimethyltrimethylene glycol, hexamethylene glycol, decamethylene glycol, 2-methyl-1,3-propanediol, 3-methyl-1,5-pentylene glycol, dihydroxy cyclohexane, cyclohexane dimethanol, resorcinol, hydroquinone, 1,5-dihydroxy naphthalene, bis(p-hydroxy)diphenyl, bis(p-hydroxyphenyl)methane, bis(p-hydroxyphenyl)propane, and combinations thereof.

3. The acetaldehyde scavenger of claim 2, wherein said diol compound is selected from the group consisting of propylene glycol, butylene glycol, pentamethylene glycol, hexamethylene glycol, 2-methyl-1,3-propanediol, and combinations thereof.

4. The acetaldehyde scavenger of claim 1, wherein said aromatic dicarboxylic acid is selected from the group consisting of terephthalic acid, isophthalic acid, phthalic acid, bi-benzoic acid, bis(p-carboxyphenyl)methane, 1,5-naphthalene dicarboxylic acid, 2,6-naphthalene dicarboxylic acid, 2,7-naphthalene dicarboxylic acid, p-oxy(p-carboxyphenyl)benzoic acid, ethylene-bis(p-oxybenzoic acid)phenanthrene dicarboxylic acid, anthracene dicarboxylic acid, 4,4′-sulfonyl dibenzoic acid, and combinations thereof.

5. The acetaldehyde scavenger of claim 4, wherein said aromatic dicarboxylic acid is selected from the group consisting of terephthalic acid, isophthalic acid, phthalic acid, and combinations thereof.

6. The acetaldehyde scavenger of claim 1, wherein said polymerization product is selected from the group consisting of polypropylene terephthalate, polybutylene terephthalate, polybutylene(terephthalate-isophthalate), polypentylene terephthalate, polyhexylene terephthalate, poly(2-methyl-1,3-propylene)terephthalate, and combinations thereof.

7. The acetaldehyde scavenger of claim 1, wherein said polymerization product has a relative viscosity ranging from 0.5 to 5.0.

8. The acetaldehyde scavenger of claim 7, wherein said polymerization product has a relative viscosity ranging from 1.0 to 4.0.

9. The acetaldehyde scavenger of claim 8, wherein said polymerization product has a relative viscosity ranging from 1.5 to 3.0.

10. The acetaldehyde scavenger of claim 1, wherein said polymerization product has a melting point ranging from 30° C. to 280° C.

11. The acetaldehyde scavenger of claim 10, wherein said polymerization product has a melting point ranging from 40° C. to 265° C.

12. The acetaldehyde scavenger of claim 11, wherein said polymerization product has a melting point ranging from 50° C. to 250° C.

13. A polyester blend comprising:
a blending product of an acetaldehyde scavenger and polyethylene terephthalate;
wherein the acetaldehyde scavenger is a polymerization product of at least one of an aromatic dicarboxylic acid having a carbon number from 8 to 16 and an ester derivative of the aromatic dicarboxylic acid, and a diol compound having a carbon number from 3 to 15.

14. The polyester blend of claim 13, wherein said acetaldehyde scavenger is in an amount ranging from 0.1 to 30 parts by weight per 100 parts by weight of said blending product.

15. The polyester blend of claim 14, wherein said acetaldehyde scavenger is in an amount ranging from 0.1 to 10 parts by weight per 100 parts by weight of said blending product.

16. A method for making a polyester blend, comprising:
(a) melt blending a mixture of an acetaldehyde scavenger and polyethylene terephthalate under a temperature ranging from 200° C. to 290° C. so as to form a melt blend, the acetaldehyde scavenger being a polymerization product of at least one of an aromatic dicarboxylic acid having a carbon number from 8 to 16 and an ester derivative of the aromatic dicarboxylic acid, and a diol compound having a carbon number from 3 to 15; and
(b) extruding the melt blend under a vacuum condition.

17. The method of claim 16, wherein the vacuum condition is conducted at a pressure not greater than 500 torr.

18. The method of claim 17, wherein the vacuum condition is conducted at a pressure not greater than 200 torr.
